(19) United States
(12) Patent Application Publication
(10) Pub. No.: US 2008/0146209 A1
(43) Pub. Date: Jun. 19, 2008

(54) METHOD OF TRANSFERRING A TELEPHONE CALL FROM ONE WIRELESS NETWORK TO ANOTHER; AND DUAL MODE MOBILE TELEPHONE TERMINAL FOR IMPLEMENTING THE METHOD

(75) Inventors: Raymond GASS, Bolsenheim (FR); Jean-Rene ROUSSEAU, Gif sur Yvette (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/945,728

(22) Filed: Nov. 27, 2007

(30) Foreign Application Priority Data
Nov. 28, 2006 (FR) 0655134

(51) Int. Cl. H04M 3/56

(52) U.S. Cl. 455/416

(57) ABSTRACT

This method is for transferring a telephone call (B1-B2), set up between a dual mode wireless terminal (T1) and another terminal (T2), the dual mode terminal having simultaneous access to a global wireless network (PLMN) and to a wireless local area network (WLAN), the latter including a private branch exchange (PBX) able to set up a three-way telephone conference call, and having a permanent link (IPL) to the global network (PLMN). The call (B1, B2) is supported firstly by the local area network (WLAN) without passing through the global network (PLMN), and thereafter must be supported by the local area network (WLAN) and the global network (PLMN). It consists in requesting this private branch exchange (PBX):
to set up a second call (B3-B2) between the dual mode terminal (T1) and the second terminal (T2) via the local area network (WLAN) and the global network (PLMN);
then to set up a telephone conference call (B1-B2-B3) combining the first and second calls;
then to clear down the first call leaving the second call (B1-B3).

The invention concerns a method of transferring a telephone call from a global wireless telecommunication network, of GSM type for example, to a local wireless telecommunication network, of WiFi or Bluetooth type for example, and vice-versa. It also concerns a dual mode terminal including means for implementing this method. It concerns more particularly wireless local area networks that include at least one private branch exchange able to set up a telephone conference call.

A dual mode mobile telephone terminal has two radio interfaces respectively enabling communication via a global wireless telecommunication network, according to the GSM standard for example, and/or via a local wireless telecommunication network, according to the WiFi standard for example, the latter being connected to a fixed public telecommunication network by a permanent link utilizing the Internet Protocol (hereinafter denoted IP) that enables telephone calls of the Voice over Internet Protocol (VoIP, Voice Over IP) type.

The global network offers coverage at the scale of a country but calls are costly. The local area network offers a more restricted coverage, included within the preceding coverage, but calls of the Voice over Internet Protocol (VoIP, Voice over IP) type are relatively inexpensive. A shopping center or an airport can be equipped with a wireless local area network accessible to the public.

When a wireless local area network covers the site of an enterprise, or the apartment of a person, the use of that local area network must have the higher priority for telephone calls, because of its low cost. The terminal being mobile, the problem arises of transferring a telephone call between the two networks, without interrupting that telephone call, and without any delay that is a nuisance to users.

There is known a method called UMA (Unlicensed Mobile Access) for effecting such a transfer between a global network, of GSM or derived type, and a local area network, of WiFi or Bluetooth type for example. This known method necessitates modification of the GSM network, by installing therein dedicated servers called UMA controllers that automatically command the transfer of a call from the global network to the local area network, and vice-versa. According to the UMA method, when a mobile telephone terminal is communicating via a GSM base station and it detects the possibility of connecting to a wireless local area network, the UMA controller commands the transfer of the call to the IP link that connects the local area network to a fixed public network. The UMA controller converts the signal coming from the mobile telephone terminal, via the IP link, to make it appear to have come from another, virtual GSM base station. Consequently, when a mobile telephone terminal enters the coverage area of a wireless local area network (which it is entitled to access), the core of the GSM telephone network simply considers this terminal to have changed GSM base station, as for a standard intercellular transfer. There is therefore no break in communication while the telephone terminal is passed from a GSM radio link to a WiFi or Bluetooth radio link, or vice-versa.

The drawback of this method is that it necessitates modification of the global network concerned, which leads to installation costs and operating costs that the operator of the global network makes the user pay.

The object of the invention is to propose a method that does not necessitate any modification in the global network.

A first aspect of the invention is a method of transferring a telephone call, set up between a dual mode wireless terminal and another terminal, the dual mode terminal having simultaneous access to a global wireless network and to a wireless local area network, the latter including a private branch exchange able to set up a three-way telephone conference call, and having a permanent link to the global network; this call being supported firstly by the local area network without passing through the global network, and thereafter being supported by the local area network and the global network; characterized in that it consists in requesting this private branch exchange:
to set up a second call between the dual mode terminal and the second terminal via the local area network and the global network;
then to set up a telephone conference call combining the first and second calls;
then to clear down the first call leaving the second call.

A second aspect of the invention is a method of transferring a telephone call, set up between a dual mode wireless terminal and another terminal, the dual mode terminal having simultaneous access to a global wireless network and to a wireless local area network, the latter including a private branch exchange able to set up a three-way telephone conference call, and having a permanent link to the global network; this call being supported firstly by the local area network and the global network, and thereafter supported by the local network without passing through the global network; characterized in that it consists in requesting this private branch exchange:
to set up a second call between the dual mode terminal and the second terminal via the local area network without passing through the global network;
then to set up a telephone conference call combining the first and second calls;
then to clear down the first call leaving the second call.

The invention also consists in a dual mode wireless telephone terminal, including two radio interfaces respectively able to set up a first call and a second call respectively and simultaneously in a wireless telecommunication local area network and a wireless telecommunication global network; characterized in that it further includes control means coupled to the two radio interfaces and able to command the radio interfaces to send messages to a private branch exchange situated in the local area network to request that private branch exchange:
at the time of transferring a first call already set up in the local area network without passing through the global network, and thereafter to be transferred into a global network,
   to set up a second call between the dual mode terminal and a second terminal, via the local area network and the global network;
   then to set up a telephone conference call combining the first and second calls;
   then to clear down the first call leaving the second call;
at the time of transferring a first call already set up in a global network and a local area network, and thereafter to be transferred into this local area network without passing through this global network, to send messages to a private branch exchange situated in the local area network, to request this private branch exchange:
   to set up a second call between this dual mode terminal and a second terminal, via the local area network without passing through the global network;
   then to set up a telephone conference call combining the first and second calls;
   then to clear down the first call leaving the second call.

The invention will be better understood and other features will become apparent in the light of the following description and the accompanying figures:

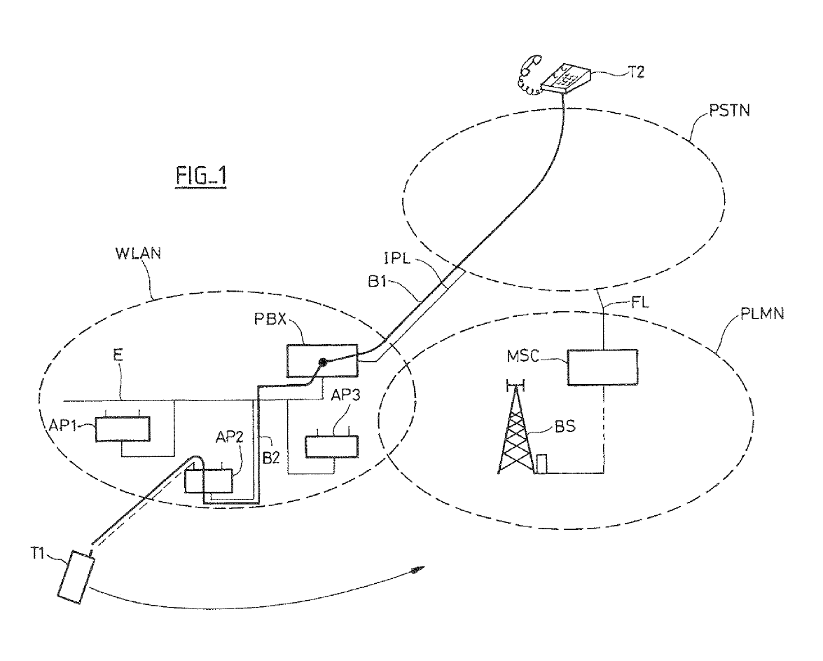

FIG. 1 illustrates a first step in the implementation of the method according to the invention.

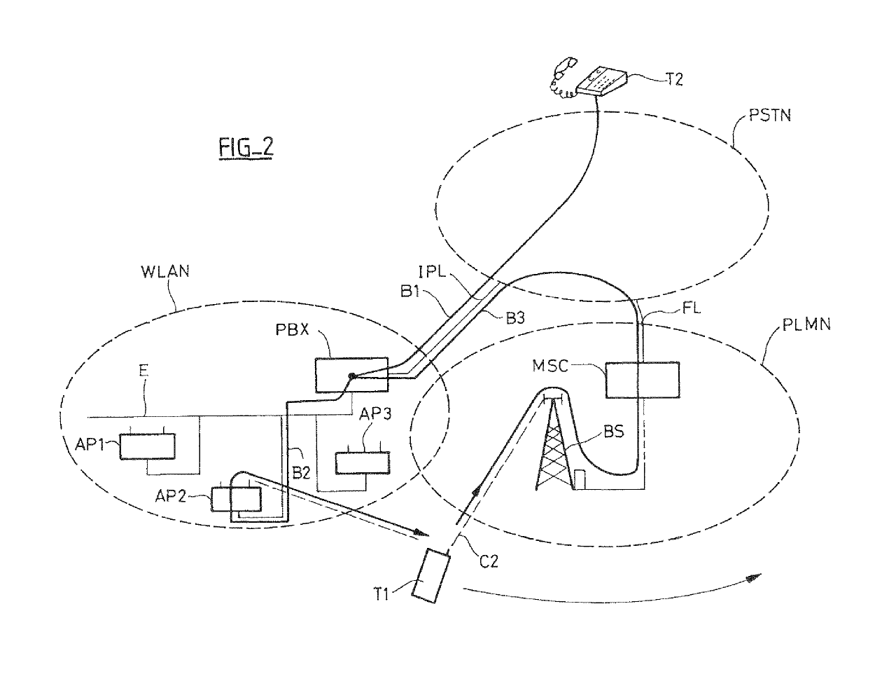

FIG. 2 illustrates a second step in the implementation of the method according to the invention.

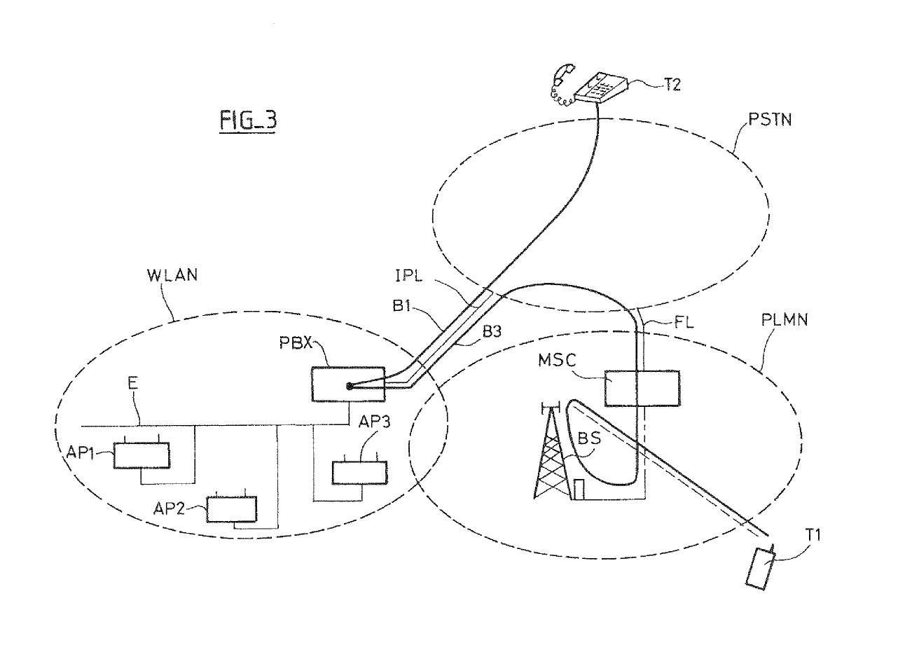

FIG. 3 illustrates a third step in the implementation of the method according to the invention.

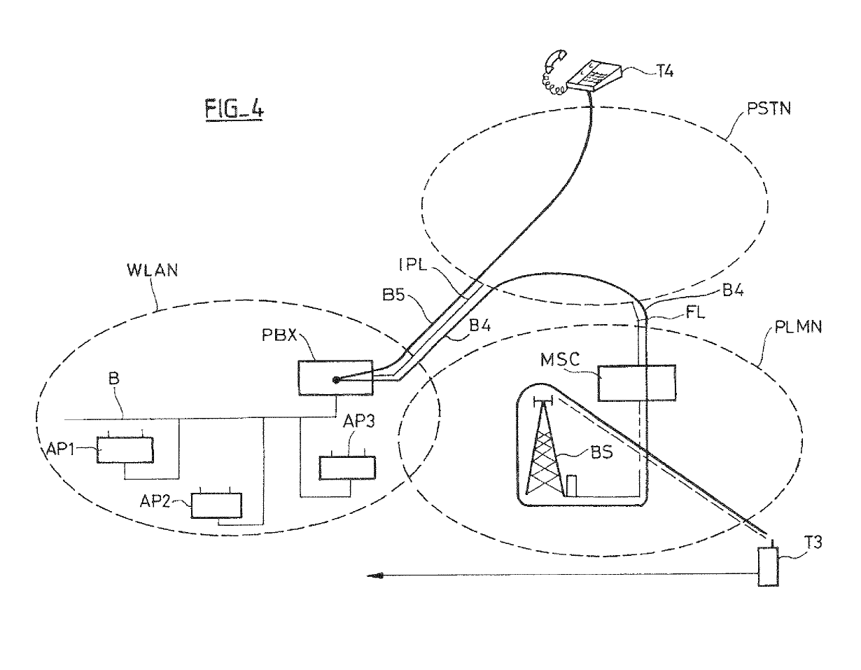

FIGS. 4, 5, 6 illustrate the transfer in the opposite direction.

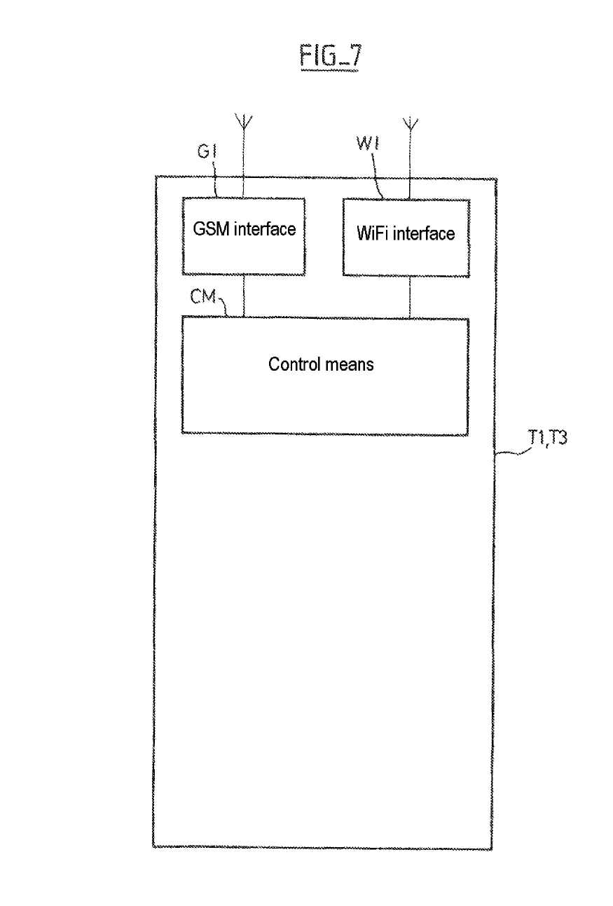

FIG. 7 represents the block diagram of one embodiment of the dual mode terminal according to the invention.

FIG. 1 illustrates a first step of the implementation of the method according to the invention in an example in which a dual mode (WiFi GSM) mobile telephone terminal T1 is in communication with a telephone terminal T2 of a fixed public switched telephone network PSTN via a wireless local area network (WLAN) of WiFi type. The local area network WLAN is connected to the fixed public network PSTN by an IP link labeled IPL in the figures. The local area network WLAN includes a private branch exchange PBX connected to radio access points AP1, AP2, AP3 by an Ethernet cable network E; and connected to the fixed public network PSTN by the link IPL. This private branch exchange PBX is able to switch Voice over Internet Protocol type calls within the local area network WLAN providing supplementary services, in particular enabling three-way conference calls.

At the moment the call concerned is set up, the terminal T1 is in the middle of the coverage area of the local area network WLAN. The terminal T1 is also in the coverage area of a global wireless network PLMN, of GSM type in this example. The call concerned is set up via the local area network WLAN rather than via the global network PLMN, to benefit from a much more advantageous tariff. The network is selected manually by the user or by an automatic process known in the art. The private branch exchange PBX sets up a connection that comprises one branch B1 connecting the private branch exchange PBX to the fixed public network PSTN via the link IPL and one branch B2 connecting the private branch exchange PBX to the terminal T1 via the radio access point AP2.

FIG. 2 illustrates a second step of the implementation of the method according to the invention. The mobile terminal T1 is moving and approaching the limit of the radio coverage of the local area network WLAN. A procedure for transferring the call B1-B2 from the local area network WLAN to the global network PLMN is triggered, either automatically by the terminal T1 when it detects a drop in the amplitude of the signal received from the access point AP2, and that it can no longer use either of the other radio access points AP1 and AP3; or manually by the user of the terminal T1.

The GSM radio interface of the dual mode terminal T1 listens periodically to the GSM base stations that it can pick up. It knows that it can set up a call via the base station BS in this example. Via its GSM interface, the dual mode terminal T1 requests the setting up of a second call, by sending the mobile service switching center MSC a message containing a called number and a calling number that are both the number of the terminal T1 in the public dialing plan that is common to the global wireless network PLMN and the fixed public network PSTN. This number includes a first field that designates the private branch exchange PBX and a second field that designates the extension that the terminal T1 constitutes when it is connected to the local area network WLAN. The mobile service switching center MSC communicates with the private branch exchange PBX via the fixed network PSTN, a fixed link FL connecting the mobile service switching center MSC to the fixed public network PSTN.

This second call is set up in the usual way, in the local area network WLAN, by the method known as direct inward dialing: the private branch exchange PBX is designated by the first field of the number; it receives the called number and extracts the second field from it, and then sends a call request signal to the extension whose number is contained in this second field. In this instance, the private branch exchanger PBX knows that this extension is the dual mode mobile terminal T1 that is associated with the radio access point AP2. The private branch exchange PBX makes a connection between the branch B2 and a new branch B3 that connects the private branch exchange PBX to the global network PLMN.

The mobile terminal T1 therefore receives a call request notification, over its WiFi interface, in the usual way. It receives signaling data that contains the called party's number and the calling party's number. According to the invention, the terminal T1 includes means for:
analyzing the calling number,
detecting if the calling number is identical to the called number (its own number), and
if this is the case: accepting a second call, and then requesting a conference call comprising this second call B2-B3 and the first call B1-B2, in the usual way for a three-way conference call (in cases where the terminal receives a second call request over the WiFi radio interface when it is in communication via the GSM radio interface, it sends a signal refusing the second call request).

The dual mode terminal T1 is then in communication with the terminal T2 simultaneously via two telephone calls, B1-B2 and B1-B3, now constituting a conference call.

FIG. 3 illustrates a third step of the method according to the invention. The terminal T1 receives over its WiFi radio interface a signaling message informing it that the private branch exchange PBX has set up the conference call it requested. The terminal T1 then automatically requests the private branch exchange PBX to clear down the first call. The private branch exchange PBX clears down the branch B2. It maintains the connection between the branch B3 and the branch B1. The second call B1-B3 replaces the first call without any inconvenience to the users: there is no interruption because both calls coexist for a certain time.

For the users, everything happens as if the radio segment of the call had been transferred instantaneously from the local area network WLAN to the global network PLMN. Note that the call continues to pass through the private branch exchange PBX and that the user of the terminal T1 therefore continues to benefit from the services that that private branch exchange can provide.

Conversely, FIGS. 4, 5, 6 illustrate the transfer in the opposite direction, that is to say from the global network PLMN to the local area network WLAN. These networks are the same as in FIGS. 1 to 3, and will therefore not be described again.

FIG. 4 illustrates a first step of the transfer in the opposite direction. Initially, a dual mode (WiFi/GSM) mobile telephone terminal T3 is in communication with a telephone terminal T4 of the fixed public network PSTN via the global wireless network PLMN. Note that this call also passes through the private branch exchange PBX of the wireless local area network WLAN, for the following reasons. This terminal T3 and the local area network WLAN typically belong to an enterprise. Outgoing calls from this private branch exchange PBX that are to use the global network PLMN have the benefit of a particularly beneficial tariff from the operator of the global network PLMN because of the large number of calls billed to the enterprise. On the other hand, the user of the terminal T3 can beneficially request the setting up of his GSM calls via the private branch exchange PBX of the enterprise that employs him, because he then has access to supplementary services provided by that private branch exchange, in particular a directory of the enterprise.

At the time the call is set up, the terminal T3 is far from the coverage area of the local area network WLAN. However, it is in the coverage area of the global wireless network PLMN. The network is selected manually by the user or by an automatic process known in the art. The private branch exchange PBX sets up a connection between a branch B4 connecting the private branch exchange PBX to the global network PLMN via the link IPL and the fixed public network PSTN and a branch B5 connecting the private branch exchange PBX to the terminal T4 via the permanent link IPL.

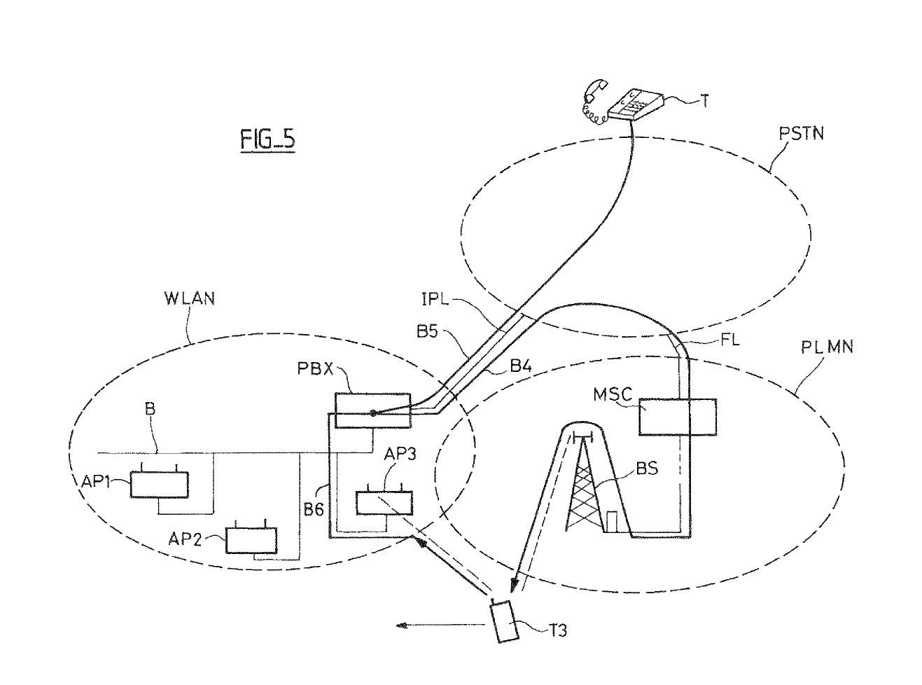

FIG. 5 illustrates a second step of the method according to the invention. The mobile terminal T3 is moving around and is entering the coverage area of the local area network WLAN. The WiFi interface of the dual mode terminal T3 listens to the WiFi access points periodically. A procedure for transferring the call from the local area network WLAN to the global network PLMN is triggered either automatically by the terminal T3 when it detects that it is in the coverage area of the local area network WLAN, and it has verified that it is entitled to access that network, or manually by the user of the terminal T3.

The WiFi interface of the dual mode terminal T3 is associated with the access point AP3, for example, and then has itself authenticated by the local area network WLAN, in accordance with a known method. The terminal T3 signals its presence to the private branch exchange PBX. The private branch exchange PBX knows that the terminal T3 is associated with the access point AP3, by a standard method. From this point on it can route a call to that terminal T3, if it is called.

The terminal T3 then requests the private branch exchange PBX to set up a second call, calling a number that is its own number in the numbering plan common to the fixed public network PSTN and the global network PLMN. That number includes a first field that designates the private branch exchange PBX and a second field that designates the extension that the terminal T3 constitutes when it is connected to the local area network WLAN.

During this time, the terminal T3 continues to communicate with the terminal T4 via the base station BS, the mobile service switching center MSC, and the fixed link FL.

The private branch exchange PBX receives the message requesting the setting up of a second call. It sets up that second call in an absolutely standard manner:
it sets up a new branch B6 that connects the private branch exchange PBX to the access point AP3 because the terminal T3 is associated with that access point AP3;
it connects this new branch B6 with the branch B5 that goes to the terminal T3 that is designated by the called number.

The mobile terminal T3 therefore receives a call request notification over its GSM interface in the standard way. It receives signaling data that contains the called party's number and the calling party's number. According to the invention, the terminal T3 includes means for:
analyzing this calling party's number,
detecting if the calling party's number is identical to the called party's number (its own number), and
if this is the case: accepting the second call, and then requesting that a conference call be set up combining this second call B4-B5 and the first call B3-B4, in the standard manner for a three-way conference call (if the terminal receives a second call request over the GSM radio interface while it is in communication via the WiFi radio interface, it sends a signal refusing the second call request).

The dual mode terminal T3 is then in communication with the terminal T4 simultaneously via two telephone calls, B1-B2 and B1-B3, combined in the conference call, via its WiFi interface and its GSM interface simultaneously.

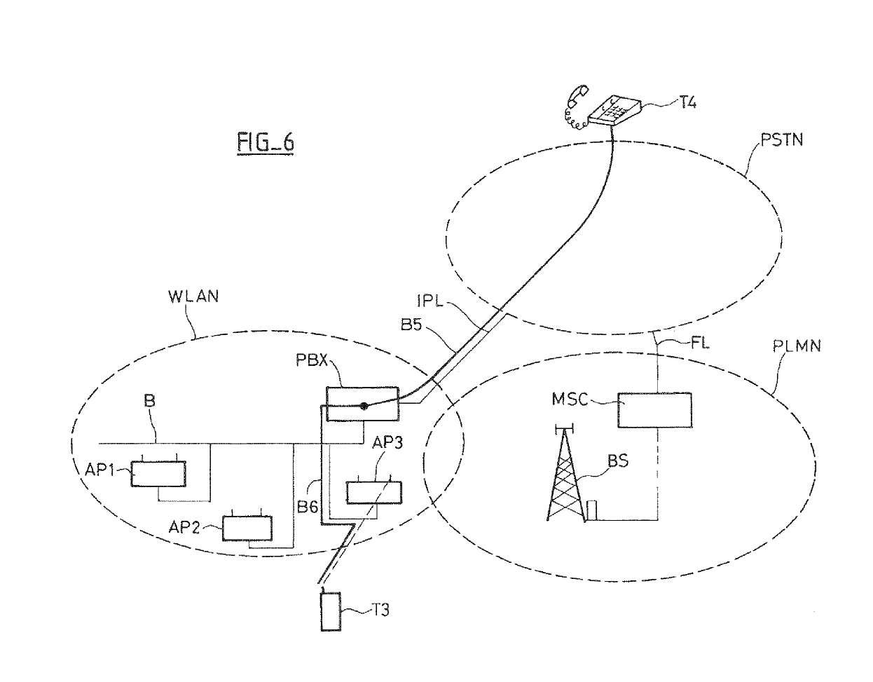

FIG. 6 illustrates a third step of the method according to the invention. As soon as the private branch exchange PBX has indicated to the terminal T3 that it has set up the conference call, the terminal T3 commands the clearing down of the first call B4-B5, in the standard way. The private branch exchange PBX clears down the branch B4. It maintains the connection between the branch B5 and the branch B6. The second call B5-B6 replaces the first call B4-B5 without any inconvenience to the users: there is no interruption because there is a short time during which the two calls coexist. For the users, everything happens as if the radio segment of the call had been transferred instantaneously from the global network PLMN to the local area network WLAN.

This method has the remarkable advantage that it does not necessitate any modification in the equipment of the local area network WLAN and the global network PLMN.

It is to be noted that the terminals T2 and T4 are any terminals of the fixed network PSTN, but that they could be any terminals of the global wireless network PLMN or of a local area network, for example the local area network WLAN itself.

In a different embodiment, instead of calling its own number to request the setting up of a second call, the dual mode mobile terminal T1 or T3 could use a method known as Direct Inward System Access (DISA): the terminal would call a predetermined number that would enable it to access the private branch exchange PBX and launch a particular application. In this instance, the particular application would set up a second call. The terminal would then request that application to set up a conference call by combining the first and second calls, and would then request it to clear down the first call.

FIG. 7 represents the block diagram of one embodiment of the dual mode terminal according to the invention, for example the block diagram of the terminals T1 and T3 referred to hereinabove with reference to FIGS. 1-6. This embodiment includes:
a standard radio interface GI for communicating with a global mobile network, of GSM type for example, such as the network PLMN described hereinabove;
a standard radio interface WI for communicating with a mobile local area network, of WiFi type for example, such as the network WLAN described hereinabove;
control means CM coupled to the two radio interfaces GI and WI and consisting of a microprocessor executing a program performing the following operations:
   To transfer from a local area network such as WLAN to a global network such as PLMN a first call already set up in the local area network without the global network, the control means CM send messages to a private branch exchange, such as PBX, situated in the local area network to request that private branch exchange:
      to set up a second call, such as B1-B3, between the dual mode terminal and a second terminal, via the local area network WLAN and the global network PLMN;
      then to set up a telephone conference call, such as B1-B2-B3, combining the first and second calls;
      then to clear down the first call leaving the second call B1-B3.
   To transfer from a global network, such as PLMN, to a local area network, such as WLAN, without passing via the global network PLMN, a first call, such as B4-B5, already set up in this global network and this local area network, the control means CM send messages to a private branch exchange, such as PBX, situated in the local area network to request that private branch exchange:
      to set up a second call, such as B5-B6 between this dual mode terminal and a second terminal, via the local area network without the global network;
      then to set up a telephone conference call, such as B4-B5-B6, combining the first and second calls;
      then to clear down the first call leaving the second call.

According to a first embodiment, the control means CM are able to command the radio interfaces GI and WI to send to a private branch exchange of the local area network messages containing a call set-up request containing a calling number and a called number both of which are the number of the dual mode terminal in the public dialing plan common to the global network PLMN and the fixed public network PSTN.

According to a second embodiment, the control means CM are adapted to command the radio interfaces GI and WI to send to a private branch exchange messages containing a call set-up request containing a predetermined dedicated number for this call transfer request.

1. Method of transferring a telephone call (B1-B2), set up between a dual mode wireless terminal (T1) and another terminal (T2), the dual mode terminal having simultaneous access to a global wireless network (PLMN) and to a wireless local area network (WLAN), the latter including a private branch exchange (PBX) able to set up a three-way telephone conference call, and having a permanent link (IPL) to the global network (PLMN); this call (B1, B2) being supported firstly by the local area network (WLAN) without passing through the global network (PLMN), and thereafter being supported by the local area network (WLAN) and the global network (PLMN); characterized in that it consists in requesting this private branch exchange (PBX):
to set up a second call (B3-B2) between the dual mode terminal (T1) and the second terminal (T2) via the local area network (WLAN) and the global network (PLMN);
then to set up a telephone conference call (B1-B2-B3) combining the first and second calls;
then to clear down the first call leaving the second call (B1-B3).

2. Method according to claim 1, characterized in that to request the private branch exchange (PBX) to set up a second call (B3-B2) between the dual mode terminal (T1) and the second terminal (T2) via the local area network (WLAN) and the global network (PLMN) it consists in sending the private branch exchange (PBX) a call set-up request containing a calling number and a called number that both consist of the number of the dual mode terminal (T1) in the numbering plan of the local area network.

3. Method according to claim 1, characterized in that to request the private branch exchange (PBX) to set up a second call (B3-B2) between the dual mode terminal (T1) and the second terminal (T2) via the local area network (WLAN) and the global network (PLMN), it consists in sending the private branch exchange (PBX) a call set-up request containing a predetermined dedicated number for requesting a call transfer.

4. Method of transferring a telephone call (B1-B2), set up between a dual mode wireless terminal (T1) and another terminal (T2), the dual mode terminal having simultaneous access to a global wireless network (PLMN) and to a wireless local area network (WLAN), the latter including a private branch exchange (PBX) able to set up a three-way telephone conference call, and having a permanent link (IPL) to the global network (PLMN); this call (B1, B2) being supported firstly by the local area network (WLAN) and the global network (PLMN), and thereafter supported by the local network (WLAN) without passing through the global network (PLMN); characterized in that it consists in requesting this private branch exchange (PBX):
to set up a second call (B5-B6) between the dual mode terminal (T3) and the second terminal (T4) via the local area network (WLAN) without passing through the global network (PLMN);
then to set up a telephone conference call (B4-B5-B6) combining the first and second calls;
then to clear down the first call leaving the second call (B5-B6).

5. Method according to claim 4, characterized in that to request the private branch exchange (PBX) to set up a second call (B5-B6) between the dual mode terminal (T3) and the second terminal (T4) via the local area network (WLAN) without the global network (PLMN) it consists in sending the private branch exchange (PBX) a call set-up request containing a calling number and a called number that both consist of the number of the dual mode terminal (T3) in the numbering plan of the local area network (WLAN).

6. Method according to claim 4, characterized in that to request the private branch exchange (PBX) to set up a second call (B5-B6) between the dual mode terminal (T3) and the second terminal (T4) via the local area network (WLAN) without the global network (PLMN), it consists in sending the private branch exchange (PBX) a call set-up request containing a predetermined dedicated number for requesting a call transfer.

7. Dual mode wireless telephone terminal (T1; T3), including two radio interfaces (WI, GI) respectively able to set up a first call and a second call respectively and simultaneously in a wireless telecommunication local area network (WLAN) and a wireless telecommunication global network (PLMN); characterized in that it further includes control means (CM) coupled to the two radio interfaces and able to command the radio interfaces to send messages to a private branch exchange (PBX) situated in the local area network to request that private branch exchange:
at the time of transferring a first call (B1-B2) already set up in the local area network (WLAN) without passing through the global network (PLMN), and thereafter to be transferred into a global network (PLMN),
to set up a second call (B1-B3) between the dual mode terminal and a second terminal, via the local area network (WLAN) and the global network (PLMN);
then to set up a telephone conference call (B1-B2-B3) combining the first and second calls;
then to clear down the first call (B1-B2) leaving the second call (B1-B3);
at the time of transferring a first call (B4-B5) already set up in a global network (PLMN) and a local area network (WLAN), and thereafter to be transferred into this local area network (WLAN) without passing through this global network (PLMN), to send messages to a private branch exchange (PBX) situated in the local area network (WLAN), to request this private branch exchange:
to set up a second call (B5-B6) between this dual mode terminal and a second terminal, via the local area network (WLAN) without the global network (PLMN);
then to set up a telephone conference call (B4-B5-B6) combining the first and second calls;
then to clear down the first call (B4-B5) leaving the second call (B5-B6).

8. Terminal according to claim 7, characterized in that said control means (CM) are adapted to command the radio interfaces to send a private branch exchange (PBX) a request to set up a second call, containing a calling number and a called number that are identical to the number of this terminal in a public numbering plan; and are adapted to:
receive a call request notification containing a calling number and a called number,
analyze this calling number,
detect if the calling number is identical to the called number, and
if this is the case, accept the setting up of a second call, and then to request the setting up of conference call combining this second call with the first call.

9. Terminal according to claim 7 characterized in that said control means (CM) are adapted to command the radio interfaces to send a private branch exchange (PBX) a call set-up request containing a predetermined dedicated called number for requesting a call transfer.
